(19) United States
(12) Patent Application Publication
(10) Pub. No.: US 2025/0112431 A1
(43) Pub. Date: Apr. 3, 2025

(54) METHOD OF MANUFACTURING ELECTRIC WIRE BUNDLE AND METHOD OF MANUFACTURING ELECTRIC WIRE ASSEMBLY

(71) Applicant: Yazaki Corporation, Tokyo (JP)

(72) Inventor: Yasunori NABETA, Shizuoka (JP)

(73) Assignee: Yazaki Corporation, Tokyo (JP)

(21) Appl. No.: 18/904,200

(22) Filed: Oct. 2, 2024

(30) Foreign Application Priority Data
Oct. 3, 2023 (JP) 2023-172029

(51) Int. Cl. H01R 43/02; B23K 20/10; B23K 101/32

(52) U.S. Cl. CPC H01R 43/0207; B23K 20/10; B23K 2101/32

(57) ABSTRACT

Provided is a method of manufacturing an electric wire bundle that is formed by joining a plurality of terminal-equipped electric wires to each other, the terminal-equipped electric wires being formed by connecting terminal fittings to one end of electric wires having conductors covered with insulator covers, the method including: heating the insulator covers in the plurality of terminal-equipped electric wires to expand the insulator covers; and ultrasonically joining the plurality of conductors to each other by applying ultrasonic vibration to the plurality of conductors exposed from the plurality of terminal-equipped electric wires while the insulator covers are expanded.

### CROSS REFERENCE TO RELATED APPLICATION

The present application is based on, and claims priority from the prior Japanese Patent Application No. 2023-172029, filed on Oct. 3, 2023, the entire contents of which are incorporated herein by reference.

### TECHNICAL FIELD

The present disclosure relates to a method of manufacturing an electric wire bundle, and a method of manufacturing an electric wire assembly.

### BACKGROUND

Conventionally, as a method of connecting a plurality of electric wires without using a connecting component such as a connector, a method has been proposed in which a plurality of conductors exposed from terminals of a plurality of electric wires are directly joined to form a conductor joint. Specifically, a plurality of conductors are set together in a joining machine for joining the conductors, and the conductors are joined by performing ultrasonic joining processing thereto.

When a terminal-equipped electric wire having one end, to which a terminal fitting is crimped, is used as an electric wire, and if ultrasonic vibration is applied to the terminal-equipped electric wire, the vibration propagates to the terminal fitting through a conductor. Therefore, there is a risk of rupture at a portion with relatively low strength, such as a bent portion of the terminal fitting. Therefore, JP 2020-177863 A proposes a technique of suppressing breakage of a terminal fitting by reducing propagation of vibration to the terminal fitting. Specifically, JP 2020-177863 A discloses a method of manufacturing a terminal-equipped electric wire in which a terminal fitting is connected to one end of an electric wire having a conductor covered with a sheath, an intermediate portion of the electric wire is sandwiched between a pair of plate bodies, and ultrasonic vibration is applied to the conductor exposed at the other end of the electric wire to perform ultrasonic joining processing thereto.

### SUMMARY OF THE INVENTION

JP 2020-177863 A discloses that propagation of the vibration to the terminal fitting is suppressed by sandwiching each electric wire between a pair of jigs (plate bodies). However, in order to suppress propagation of the vibration, it is necessary to apply sufficiently pressure to each electric wire with jigs, and for this purpose, it is desirable to use jigs suitable for each electric wire. Therefore, there is a demand for a method which enables suppression of propagation of ultrasonic vibration to a terminal fitting in a simpler manner.

The present disclosure has been made in view of the problem of the previously existing technology. An object of the present disclosure is to provide a method of manufacturing an electric wire bundle and a method of manufacturing an electric wire assembly which enable suppression of propagation of ultrasonic vibration to a terminal fitting in a simpler manner.

A method of manufacturing an electric wire bundle according to the present embodiment is a method of manufacturing an electric wire bundle that is formed by joining a plurality of terminal-equipped electric wires to each other, the terminal-equipped electric wires being formed by connecting terminal fittings to one end of electric wires having conductors covered with insulator covers, the method including: heating the insulator covers in the plurality of terminal-equipped electric wires to expand the insulator covers; and ultrasonically joining the plurality of conductors to each other by applying ultrasonic vibration to the plurality of conductors exposed from the plurality of terminal-equipped electric wires while the insulator covers are expanded.

A method of manufacturing an electric wire assembly according to the present embodiment is a method of manufacturing an electric wire assembly that is formed by joining a conductive member to a terminal-equipped electric wire, the terminal-equipped electric wire being formed by connecting a terminal fitting to one end of an electric wire having a conductor covered with an insulator cover, the method including: heating the insulator cover in the terminal-equipped electric wire to expand the insulator cover; and ultrasonically joining the conductor and the conductive member by applying ultrasonic vibration to the conductor exposed from the terminal-equipped electric wire while the insulator cover is expanded.

According to the above configuration, it is possible to provide a method of manufacturing an electric wire bundle and a method of manufacturing an electric wire assembly which enable suppression of propagation of ultrasonic vibration to a terminal fitting in a simpler manner.

### BRIEF DESCRIPTION OF DRAWINGS

FIG. 1A is a perspective view schematically illustrating an example of a terminal-equipped electric wire used in a method of manufacturing an electric wire bundle according to the present embodiment.

FIG. 1B is a schematic diagram illustrating a cross section of a terminal fitting in the terminal-equipped electric wire.

FIG. 2 is a schematic diagram illustrating a state in which a plurality of terminal-equipped electric wires are mounted in an ultrasonic joiner in the method of manufacturing an electric wire bundle according to the present embodiment.

FIG. 3 is a schematic diagram illustrating a state in which the plurality of terminal-equipped electric wires are heated in the method of manufacturing an electric wire bundle according to the present embodiment.

FIG. 4 is a schematic diagram illustrating a state in which the plurality of terminal-equipped electric wires are ultrasonically joined while being heated in the method of manufacturing an electric wire bundle according to the present embodiment.

FIG. 5 is a schematic diagram illustrating another example of a state in which a plurality of terminal-equipped electric wires are heated in the method of manufacturing an electric wire bundle according to the present embodiment.

FIG. 6 is a schematic diagram illustrating another example of a state in which a plurality of terminal-equipped electric wires are heated in the method of manufacturing an electric wire bundle according to the present embodiment.

FIG. 7 is a schematic diagram illustrating a state in which a terminal-equipped electric wire is heated in a method of manufacturing an electric wire assembly according to the present embodiment.

### DETAILED DESCRIPTION OF THE INVENTION

A method of manufacturing an electric wire bundle and a method of manufacturing an electric wire assembly according to the present embodiment will be described in detail below with reference to the drawings. Note that dimensional ratios in the drawings are exaggerated for illustrative purposes and may differ from actual ratios.

### Method of Manufacturing Electric Wire Bundle

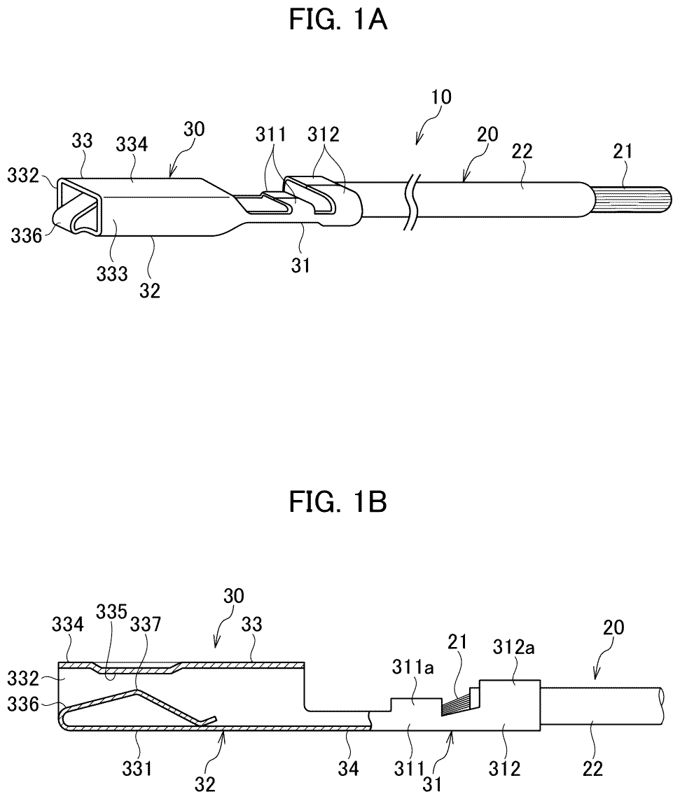

A method of manufacturing an electric wire bundle of the present embodiment is a method of manufacturing an electric wire bundle formed by directly joining conductors of a plurality of terminal-equipped electric wires 10. As illustrated in FIGS. 1A and 1B, each of the terminal-equipped electric wires 10 includes an electric wire 20 and a terminal fitting 30 which is connected to one end of the electric wire 20.

The electric wire 20 is an insulated electric wire which has a conductor 21 and an insulator cover 22 covering the periphery of the conductor 21. For the conductor 21, it is possible to use a twisted wire formed by twisting element wires made of conductive metal materials such as copper, copper alloys, aluminum, or aluminum alloys, for example. The insulator cover 22 is formed of a resin material having flexibility and electrical insulation. The insulator covers 22 at both ends of the electric wire 20 are removed and a part of the conductor 21 is exposed.

The terminal fitting 30 is crimped to one end of the electric wire 20 of which the conductor 21 is exposed. The terminal fitting 30 is formed by processing a plate made of a conductive metal material such as copper, a copper alloy, aluminum, or an aluminum alloy, for example. As illustrated in FIG. 1B, the terminal fitting 30 includes an electric wire connector 31 and an electrical connector 32.

The electric wire connector 31 of the terminal fitting 30 has a conductor crimper 311 which is crimped to the conductor 21 of the electric wire 20, and a cover crimper 312 which is crimped to the insulator cover 22 of the electric wire 20. The conductor crimper 311 has a pair of conductor crimping pieces 311a. The conductor 21 is crimped and fixed to the conductor crimper 311 by press-fastening the conductor crimping pieces 311a. Similarly, the cover crimper 312 has a pair of cover crimping pieces 312a, and the insulator cover 22 is crimped and fixed to the cover crimper 312 by press-fastening the cover crimping pieces 312a. This connects the terminal fitting 30 with the electric wire 20, and electrically connects the terminal fitting 30 with the conductor 21 of the electric wire 20.

The electrical connector 32 of the terminal fitting 30 has a square tubular box 33 into which a tab formed on a male terminal of a connection mating portion is inserted from a distal end side thereof. A coupler 34 is disposed on a side opposite to the tab insertion side of the electrical connector 32, and the electric wire connector 31 and the electrical connector 32 are integrated with the coupler 34 therebetween.

The box 33 of the electrical connector 32 includes a bottom plate 331, side plates 332 and 333 erected from both edges of the bottom plate 331, and a top plate 334 closing an upper portion of the box 33. A contact 335 projecting toward the inside of the box 33 is formed on the top plate 334. The coupler 34 is integrally formed on the electric wire connector 31 side of the bottom plate 331, and a spring contact 336 is connected consecutively on a distal end side of the bottom plate 331. The spring contact 336 is formed in the box 33 by being folded back from the distal end of the bottom plate 331 toward the electric wire connector 31. The spring contact 336 has a pressing contact 337 which projects toward the contact 335 on the top plate 334.

When ultrasonic joining processing is performed to the conductor 21 on the other end side of the electric wire 20 having one end connected to the terminal fitting 30 in the terminal-equipped electric wire 10, ultrasonic vibration propagates to the terminal fitting 30 through the electric wire 20. The spring contact 336 vibrates in response to the propagated ultrasonic vibration in the terminal fitting 30. Therefore a large load is applied to a portion which is consecutively connected to the bottom plate 331, and there is a risk of breakage. Therefore, in the method of manufacturing an electric wire bundle according to the present embodiment, the ultrasonic vibration is suppressed from being propagated to the terminal fitting 30 when the conductors 21 of the plurality of terminal-equipped electric wires 10 are ultrasonically joined to each other.

In the method of manufacturing an electric wire bundle according to the present embodiment, first, a plurality of terminal-equipped electric wires 10 illustrated in FIGS. 1A and 1B are prepared. As described above, the insulator covers 22 at both ends of the electric wire 20 of the terminal-equipped electric wire 10 are removed and a part of the conductor 21 is exposed. Then, the terminal fitting 30 is crimped to one end of the electric wire 20.

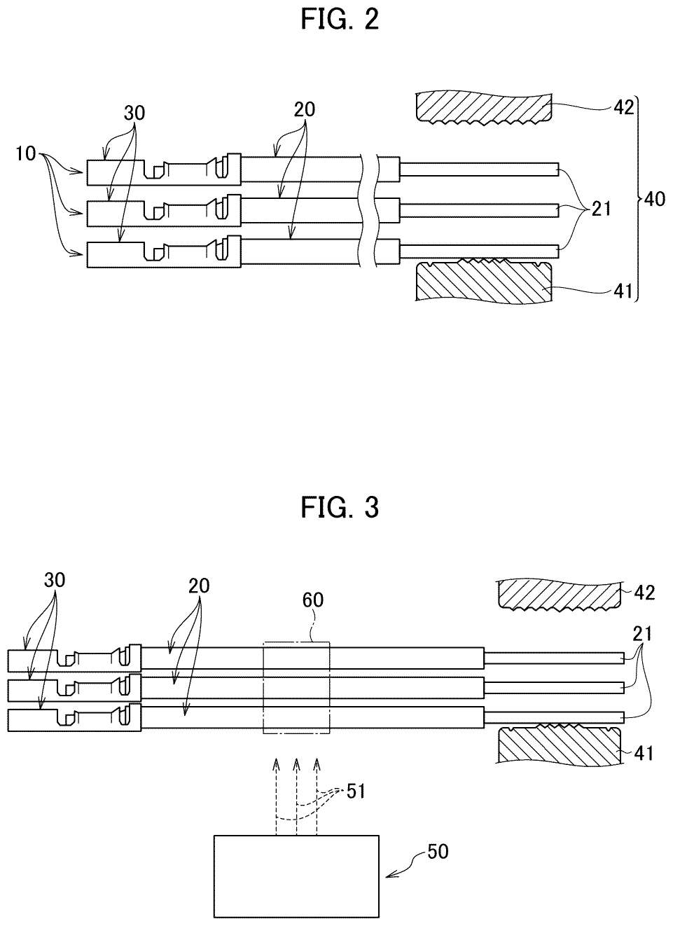

Next, as illustrated in FIG. 2, the conductors 21 exposed at the other end of the electric wire 20 are mounted in an ultrasonic joiner 40. At this time, the conductors are mounted in the ultrasonic joiner 40 in a state where ends of the plurality of conductors 21 on the other end side of the electric wire are aligned in a direction orthogonal to a longitudinal direction of the electric wire 20.

The ultrasonic joiner 40 includes a horn 41 positioned below the conductors 21 and an anvil 42 positioned above the conductors 21. Further, the ultrasonic joiner 40 includes a fixed side plate and a movable slide core on sides of the conductors 21. The horn 41 is ultrasonically vibrated in a horizontal direction in the diagram by a vibrator. Knurls constituted by a plurality of protrusions protruding in a direction orthogonal to the vibration direction are formed on an upper surface of the horn 41 (a surface in contact with the conductor 21), and this suppresses sliding between the upper surface of the horn 41 and the conductor 21. Similarly, knurls constituted by a plurality of protrusions protruding in the direction orthogonal to the vibration direction are formed on a lower surface of the anvil 42. A space defined by the horn 41, the side plate, the slide core, and the anvil 42 of the ultrasonic joiner 40 serves as a joining processing space, and the conductors 21 mounted in the joining processing space are ultrasonically joined to each other.

Next, the insulator covers 22 of the electric wires 20 in the plurality of terminal-equipped electric wires 10 are heated and the insulator covers 22 are expanded while the plurality of terminal-equipped electric wires 10 are mounted in the ultrasonic joiner 40. Specifically, as illustrated in FIG. 3, at least a part of each insulator cover 22 is heated using a heater 50. When each insulator cover 22 is heated, an entire heated portion 60 of each insulator cover 22 expands outward in a radial direction of each electric wire 20, and this reduces adhesion between each conductor 21 and each insulator cover 22.

A method of heating each insulator cover 22 is not particularly limited, and a heater 50 emitting warm air can be used, for example. Specifically, in a state where the heater 50 is disposed in the vicinity of each terminal-equipped electric wires 10, warm air 51 is emitted from the heater 50, and the warm air 51 is blown from a side surface of each insulator cover 22. This heats a part of each insulator cover 22 to the temperature of the warm air 51, and generates each heated portion 60. A heating medium brought into contact with each insulator cover 22 is not limited to gas, but may be a liquid.

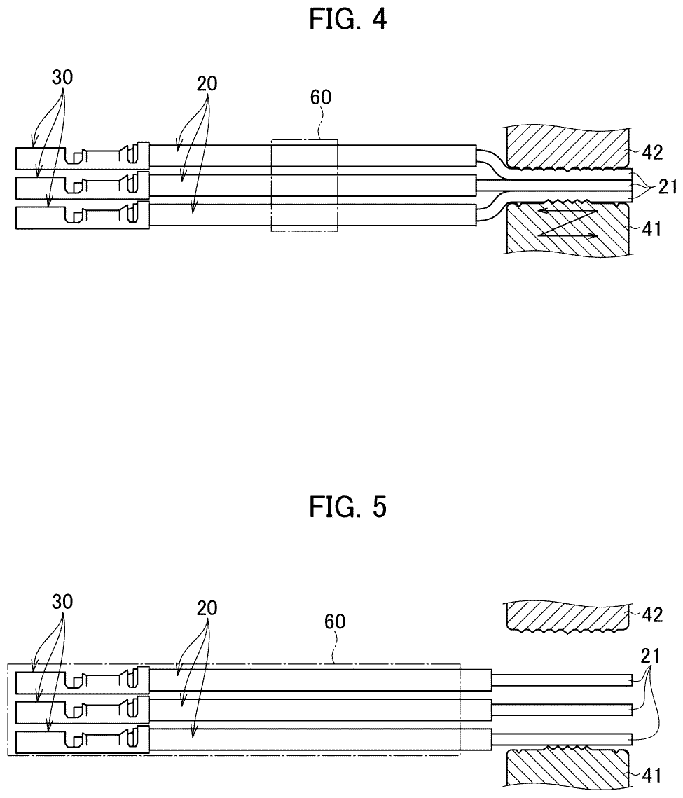

Then, ultrasonic vibration is applied to the plurality of conductors 21 mounted inside the ultrasonic joiner 40, while the insulator covers 22 are heated, and accordingly the conductors 21 are ultrasonically joined to each other. Specifically, after the plurality of conductors 21 are sandwiched between the horn 41 and the anvil 42 of the ultrasonic joiner 40 as illustrated in FIG. 4, a current is passed through the vibrator. As a result, the horn 41 is ultrasonically vibrated by the vibrator, and ultrasonic vibration energy propagates to the conductors 21. After an oxide film or the like on a surface of each conductor 21 is broken down and removed, the conductors 21 are joined to each other.

Finally, the joined conductors 21 are removed from the ultrasonic joiner 40, each insulator cover 22 is cooled to room temperature, and accordingly it is possible to obtain an electric wire bundle which is formed by ultrasonically joining the conductors 21 of the plurality of terminal-equipped electric wires 10.

If each insulator cover 22 is not heated, each conductor 21 and each insulator cover 22 are adhered to each other, and therefore the adhesion between each conductor 21 and each insulator cover 22 is high. If the adhesion between each conductor 21 and each insulator cover 22 is high, a frictional force between each conductor 21 and each insulator cover 22 is also high. Therefore, if ultrasonic vibration is applied to each conductor 21 exposed at the other end of each electric wire 20, each conductor 21 and each insulator cover 22 are integrally vibrated. That is, each conductor 21 and each insulator cover 22 vibrate at approximately the same frequency. As a result, the ultrasonic vibration propagates to each terminal fitting 30 through each conductor 21 and each insulator cover 22, and therefore there is a risk of breakage of each terminal fitting 30.

Meanwhile, when each insulator cover 22 is heated, the whole of each insulator cover 22 expands outward in the radial direction at each heated portion 60 thereof, and therefore the adhesion between each conductor 21 and each insulator cover 22 becomes low. When the adhesion therebetween becomes low, a force for moving each conductor 21 due to the ultrasonic vibration becomes larger than a static frictional force between each conductor 21 and each insulator cover 22, and therefore each conductor 21 and each insulator cover 22 vibrate separately from each other. That is, each conductor 21 and each insulator cover 22 vibrate at different frequencies. If each conductor 21 and each insulator cover 22 vibrate separately from each other, sliding occurs between each conductor 21 and each insulator cover 22, and a frictional force (dynamic frictional force) is generated between each conductor 21 and each insulator cover 22. As a result, the ultrasonic vibration propagated to each conductor 21 and each insulator cover 22 is damped by the frictional force, and therefore it becomes difficult for the ultrasonic vibration to propagate to each terminal fitting 30, and breakage of each terminal fitting 30 can be suppressed.

Therefore, it is preferable that a temperature of each insulator cover 22 when each insulator cover 22 is heated is equal to or higher than a temperature at which each insulator cover 22 expands and each conductor 21 and each insulator cover 22 start to move separately from each other. That is, it is preferable that a temperature of each insulator cover 22 when each insulator cover 22 is heated is equal to or higher than a temperature at which each insulator cover 22 expands and each conductor 21 and each insulator cover 22 vibrate at different frequencies from each other.

Incidentally, although there are no particular limitations on the upper limit of a temperature of each insulator cover 22 when each insulator cover 22 is heated, the upper limit may be the upper limit of a temperature determined when handling each electric wire 20, that is, a heat-resistant temperature, for example.

As described above, in the manufacturing method of the present embodiment, the insulator covers 22 can be heated while the plurality of terminal-equipped electric wires 10 are mounted in the ultrasonic joiner 40. However, the timing for heating the insulator covers 22 is not limited to this mode. The terminal-equipped electric wires 10 may be mounted in the ultrasonic joiner 40 after the insulator covers 22 of the plurality of terminal-equipped electric wires 10 are heated in advance, for example.

As illustrated in FIG. 3, each heated portion 60 when each insulator cover 22 is heated can be at least a part of each insulator cover 22. Each heated portion 60 can be located in the vicinity of an intermediate position between each terminal fitting 30 and each conductor 21 exposed at the other end of each electric wire 20 in each insulator cover 22, for example. Further, each heated portion 60 of each insulator cover 22 may be located in the vicinity of each terminal fitting 30 or in the vicinity of each conductor 21 exposed at the other end of each electric wire 20.

Further, as illustrated in FIG. 5, each heated portion 60 may be the whole of each terminal fitting 30 and each insulator cover 22 in each terminal-equipped electric wire 10. In particular, due to the whole of each insulator cover 22 being each heated portion 60, it becomes easy for each conductor 21 and each insulator cover 22 to vibrate separately from each other, and therefore sliding occurs between each conductor 21 and each insulator cover 22, and ultrasonic vibration is easily damped.

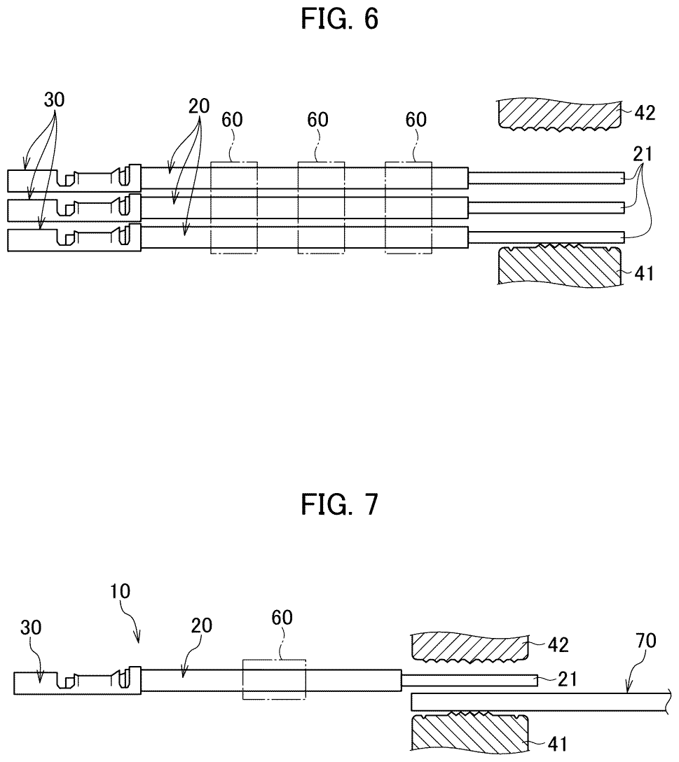

As illustrated in FIG. 3, the number of heated portions 60 of each insulator cover 22 may be one. Further, as illustrated in FIG. 6, the number of heated portions 60 may be more than one along a longitudinal direction of each electric wire 20. If the number of heated portions 60 is one, it is possible to easily heat each insulator cover 22. If the number of heated portions 60 is more than one, the number of portions where sliding occurs between each conductor 21 and each insulator cover 22 increases, and therefore ultrasonic vibration is easily damped.

As described above, there are no particular limitations on a method of heating each insulator cover 22, and each heated portion 60 may be generated by blowing warm air to each insulator cover 22. Further, each heated portion 60 may be generated by spraying a heated liquid onto each insulator cover 22. Still further, each heated portion 60 may be generated by heating each insulator cover 22 using a thermostatic chamber.

Each heated portion 60 may be generated by immersing each electric wire 20 and each terminal fitting 30 in a heated liquid, provided that there is no influence on an ultrasonic joining portion formed by ultrasonically joining the plurality of conductors 21 and a terminal crimping portion formed by crimping each terminal fitting 30 to one end of each electric wire 20.

Further, the thickness (diameters) of the electric wires 20 of the plurality of terminal-equipped electric wires 10 may be the same, or may be different from each other. In the present embodiment, each heated portion 60 can be generated in each electric wire 20 irrelevant to the thickness of each electric wire 20, and therefore the ultrasonic vibration to each terminal fitting 30 can be damped.

In this way, the method of manufacturing an electric wire bundle according to the present embodiment is a method of manufacturing an electric wire bundle, which is formed by joining the plurality of terminal-equipped electric wires 10 to each other, each of which is formed by connecting each terminal fitting 30 to one end of each electric wire 20 having each conductor 21 covered with each insulator cover 22. Further, the manufacturing method includes a step of heating the insulator covers 22 in the plurality of terminal-equipped electric wires 10 to expand the insulator covers 22. Still further, the manufacturing method includes a step of ultrasonically joining the plurality of conductors 21 to each other by applying ultrasonic vibration to the plurality of conductors 21 exposed from the plurality of terminal-equipped electric wires 10 while the insulator covers 22 are expanded.

In the manufacturing method of the present embodiment, since ultrasonic vibration is applied to the conductors 21 while the insulator covers 22 are expanded, sliding occurs between the conductors 21 and the insulator covers 22, and a frictional force is generated between the conductors 21 and the insulator covers 22. As a result, ultrasonic vibration propagated to the conductors 21 and the insulator covers 22 is damped by the frictional force, and therefore it becomes difficult for ultrasonic vibration to propagate to the terminal fittings 30, and breakage of the terminal fittings 30 can be suppressed. Further, in the manufacturing method of the present embodiment, since it is not necessary to sandwich each electric wire with a pair of jigs (plates) as disclosed in JP 2020-177863 A, propagation of ultrasonic vibration to the terminal fittings can be suppressed in a simpler manner.

In the present embodiment, a temperature of each insulator cover when each insulator cover 22 is heated may be equal to a temperature at which each conductor and each insulator cover in each terminal-equipped electric wire 10 vibrate at different frequencies, when ultrasonic vibration is applied to each conductor 21, while each insulator cover is expanded. As a result, sliding occurs between each conductor 21 and each insulator cover 22 and a frictional force is generated therebetween. This can damp ultrasonic vibration propagated to each conductor 21 and each insulator cover 22.

In the present embodiment, each insulator cover 22 may be heated by bringing at least one of heated warm air or a heated liquid into contact with each insulator cover 22. Therefore, each heated portion 60 can be generated with a simple device such as a warm air generator.

In the present embodiment, one or more portions of each insulator cover 22 in each terminal-equipped electric wire 10 may be heated. If the number of heated portions 60 is one, it is possible to heat each insulator cover 22 easily. If the number of heated portions 60 is more than one, the number of portions where sliding occurs between each conductor 21 and each insulator cover 22 increases, and therefore ultrasonic vibration is easily damped.

In the present embodiment, the whole of each terminal fitting and each insulator cover in each terminal-equipped electric wire 10 may be heated. As a result, it becomes easy for each conductor 21 and each insulator cover 22 to vibrate separately from each other. Therefore, sliding occurs between each conductor 21 and each insulator cover 22, and ultrasonic vibration is easily damped.

### Method of Manufacturing Electric Wire Assembly

Next, a method of manufacturing an electric wire assembly according to the present embodiment will be described in detail. Description overlapping with a description of the method of manufacturing an electric wire bundle described above will be omitted.

As described above, the propagation of ultrasonic vibration to a terminal fitting can be suppressed by forming the heated portion 60 in the insulator cover 22 of the terminal-equipped electric wire 10. Such a damping method can be applied not only to the manufacturing of an electric wire bundle but also to the manufacturing of an electric wire assembly which is formed by ultrasonically joining a terminal-equipped electric wire and a conductive member.

In the method of manufacturing an electric wire assembly according to the present embodiment, first, the terminal-equipped electric wire 10 is prepared. The number of terminal-equipped electric wires 10 may be one or more than one. Further, a conductive member 70 to be connected to the terminal-equipped electric wire 10 is prepared. There are no particular limitations placed on the conductive member 70, and an example of the conductive member 70 is a metal terminal different from the terminal fitting 30 or a bus bar.

Next, as illustrated in FIG. 7, the conductor 21 exposed at the other end of the electric wire 20 and the conductive member 70 are mounted in the ultrasonic joiner 40. At this time, the conductor 21 of the electric wire 20 and the conductive member 70 are mounted in the ultrasonic joiner 40 such that they overlap each other in a direction orthogonal to a longitudinal direction of the electric wire 20.

Next, the heated portion 60 is generated and the insulator cover 22 of the electric wire 20 in the terminal-equipped electric wire 10 is expanded by heating the insulator cover 22 while the terminal-equipped electric wire 10 and the conductive member 70 are mounted in the ultrasonic joiner 40.

Then, the conductor 21 and the conductive member 70 are ultrasonically joined by applying ultrasonic vibration to the conductor 21 and the conductive member 70 mounted in the ultrasonic joiner 40, while the insulator cover 22 is heated.

Finally, the joined conductor 21 and conductive member 70 are removed from the ultrasonic joiner 40, and the insulator cover 22 is cooled to room temperature. Accordingly, it is possible to obtain an electric wire assembly which is formed by ultrasonically joining the conductor 21 in the terminal-equipped electric wire 10 and the conductive member 70.

In this way, the method of manufacturing an electric wire assembly according to the present embodiment is a method of manufacturing an electric wire assembly which is formed by joining the conductive member 70 to the terminal-equipped electric wire 10, that is formed by connecting the terminal fitting 30 to one end of the electric wire 20 having the conductor 21 covered with the insulator cover 22. The manufacturing method includes a step of heating the insulator cover 22 in the terminal-equipped electric wire 10 to expand the insulator cover 22. Still further, the manufacturing method includes a step of ultrasonically joining the conductor 21 and the conductive member 70 by applying ultrasonic vibration to the conductor 21 exposed from the terminal-equipped electric wires 10 while the insulator cover 22 is expanded.

In the manufacturing method of the present embodiment, since ultrasonic vibration is applied to the conductor 21 while the insulator cover 22 is expanded, sliding also occurs between the conductor 21 and the insulator cover 22, and a frictional force is generated between the conductor 21 and the insulator cover 22. As a result, the ultrasonic vibration propagated to the conductor 21 and the insulator cover 22 is damped by the frictional force. Therefore, it becomes difficult for the ultrasonic vibration to propagate to the terminal fitting 30, and the breakage of the terminal fitting 30 can be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A method of manufacturing an electric wire bundle that is formed by joining a plurality of terminal-equipped electric wires to each other, the terminal-equipped electric wires being formed by connecting terminal fittings to one end of electric wires having conductors covered with insulator covers, the method comprising:
heating the insulator covers in the plurality of terminal-equipped electric wires to expand the insulator covers; and
ultrasonically joining the plurality of conductors to each other by applying ultrasonic vibration to the plurality of conductors exposed from the plurality of terminal-equipped electric wires while the insulator covers are expanded.

2. The method of manufacturing an electric wire bundle according to claim 1, wherein a temperature of the insulator covers when the insulator covers are heated is equal to a temperature at which a conductor and an insulator cover in each terminal-equipped electric wire vibrate at different frequencies when the ultrasonic vibration is applied to the conductors while the insulator covers are expanded.

3. The method of manufacturing an electric wire bundle according to claim 1, wherein the insulator covers are heated by bringing at least one of heated warm air or a heated liquid into contact with the insulator covers.

4. The method of manufacturing an electric wire bundle according to claim 1, wherein one or more portions of an insulator cover in each terminal-equipped electric wire are heated.

5. The method of manufacturing an electric wire bundle according to claim 1, wherein a whole of a terminal fitting and an insulator cover in each terminal-equipped electric wire is heated.

6. A method of manufacturing an electric wire assembly that is formed by joining a conductive member to a terminal-equipped electric wire, the terminal-equipped electric wire being formed by connecting a terminal fitting to one end of an electric wire having a conductor covered with an insulator cover, the method comprising:
heating the insulator cover in the terminal-equipped electric wire to expand the insulator cover; and
ultrasonically joining the conductor and the conductive member by applying ultrasonic vibration to the conductor exposed from the terminal-equipped electric wire while the insulator cover is expanded.
